(19) United States
(12) Patent Application Publication
(10) Pub. No.: US 2004/0145196 A1
(43) Pub. Date: Jul. 29, 2004

(54) Pooch pooh snatcher

(76) Inventor: Sidney I. Katz, Laguna Woods, CA (US)

Correspondence Address: Bruce B. Brunda, STETINA BRUNDA GARRED & BRUCKER, Suite 250, 75 Enterprise, Aliso Viejo, CA, 92656, US

(21) Appl. No.: 10/352,656

(22) Filed: Jan. 28, 2003

(51) Int. Cl. A01K 29/00; E01H 1/12

(52) U.S. Cl. 294/1.4

(57) ABSTRACT

A substance retrieving device comprising a receiving member, a liner, a rod member,and a handle grip member is provided. The receiving member has an open and position and is translated between those two positions when the handle grip is squeezed. The receiving member and the liner are sized and configured to substance. The liner is disposed on the inner receiving surface of the receiving and extends external to the receiving member. Additionally, a plurality of liners disposed on top of one another. The rod member is attached to the receiving at the rod member first end and to the handle grip member at the rod member end.

### CROSS-REFERENCE TO RELATED APPLICATIONS

(Not Applicable)

### STATEMENT RE: FEDERALLY SPONSORED RESEARCH/DEVELOPMENT

(Not Applicable)

### BACKGROUND OF THE INVENTION

The present invention generally relates to a device for safely gathering animal feces from off the ground. More particularly, the present invention is adapted to provide a device, so that the user does not have to bend their knees or back to gather the animal excrement from off the ground.

Pets are valued in the America. As such, a growing number of people adopt pets. One reason for this trend is that there is an increased number of elderly people whose children are leaving home to start their own family. As such, children spend less time with their parents and grandparents. In response, elderly people adopt pets as an additional source of companionship. Another reason for this trend is that society is finding more utilitarian uses for animals. For example, blind people rely on guide dogs as their eyes to safely guide them through city streets. In sum, the number of pets are increasing in America.

Pet owners must deal with a unique situation when owning a pet. With human children, unlike pets, a parent will stop cleaning up after their infant child when they grow up, whereas pet owners must continually clean up after their pets for many years. As a result, some pet owners do not clean up after their pets for reasons discussed below. This creates sanitary and aesthetic issues for communities with pet owners who do not clean up after their pets. Poop, or excrement left in public areas attract insects that can carry the excrement's germs into the surrounding homes. As a result, communities have a greater risk of contracting diseases and viruses. Alternatively, people may inadvertently walk into their home after they have unknowingly stepped into excrement increasing the risk that the family will contract a disease or virus. Lastly, excrement in public areas is visually displeasing.

In response to the safety and aesthetic concerns, communities have enacted laws requiring pet owners to clean up after their animals. Although enacting laws are effective to a certain extent in making pet owners clean up after their pets, the most effective method is to reduce the reasons people do not clean up after their pets.

People do not clean up after their pets for different reasons. For the physically challenged due to old age or physical condition, cleaning up after their pets may be painful or even dangerous. For example, a person with osteoporosis may slip and fall while bending over to clean up after their pet thereby breaking a bone. Additionally, a pet owner may experience muscle strain caused by the repeated motion of bending over to clean up after their pets. At the least, the cleaning up task is unpleasant for all pet owners because pet owners need to get close to the excrement thereby smelling its unpleasant odor. Therefore, a device that will allow a pet owner to pick up excrement without bending over and getting close to the excrement would promote more pet owners to clean up after their pets.

There are numerous prior art devices for gathering excrement from off the ground to promote pet owners to clean up after their pets. However, the prior art devices do not eliminate the reasons, as discussed above, that pet owners do not clean up after their pets. As discussed below, the prior art devices still require pet owners to bend over to clean up after their pets.

Typically, the prior art devices resemble a reduced size shovel configuration where the shovel end of the device is located close (i.e., a few inches) to the handle. This configuration requires a user to bend over to clean up after their pets. As discussed above, this bending motion is uncomfortable for those with physical disabilities, e.g., arthritis, muscular disorders, and osteoporosis, because these bending motion stress parts of the body suffering from physical ailment. Additionally, the pet owner must still smell the excrement because the pet owner must manipulate the excrement from arm's length.

Another drawback to the typical shovel type configuration is that they do not sufficiently prevent the user's hand or arm from contacting the excrement, i.e., not sanitary. The close proximity of the handle to the shovel end places the user's hand closer to the action, i.e., the point at which shovel end contacts the excrement. As a result, an accidental slippage of the hand from the handle will immerse the hand in the poop.

Other prior art devices try to eliminate the possibility of a user accidentally touching the animal's excrement by providing a liner that provides a barrier between the device and the excrement. These devices with protective liners are ineffective in protecting the user's hand from contacting the excrement. These protective liners are designed to prevent the excrement from contacting the device, not the user. As a result, the liner merely cover the fingers and the lower portion of the hand thereby leaving the upper portion of the hand vulnerable to the excrement. Additionally, the liner's opening may drop to the ground touching the excrement requiring the user to manipulate the device and the liner with excrement smeared all over the liner's opening increasing the risk that the user will contact the excrement.

The present invention addresses the above-mentioned deficiencies in the prior art devices by providing a device that can pick up animal excrements without the risk of the excrement contacting the user, i.e., a sanitary method. Additionally, the device of the present invention can pick up animal excrements without the user bending over, i.e., a safe method. Furthermore, the device of the present invention allows the user to pick up poop from a distance greater than arm's length; thus, the pet owner does not have to smell the excrement while picking it up.

### BRIEF SUMMARY OF THE INVENTION

An excrement retrieving device for facilitating the removal of an excrement from a surface. More particularly the device comprises a resilient invaginated receiving member, a liner, a rod member, and a handle grip member.

The characteristics particular to each element will be discussed. The resilient invaginated receiving member is deformable between a open position and a closed position. When the resilient invaginated receiving member is in the closed position, it defines an inner receiving surface that is sized and configured to receive excrement. The liner extends external to the resilient invaginated receiving member and defines a mating surface and a excrement engaging surface. The mating surface of the liner is disposed on the inner receiving surface of the resilient invaginated receiving member. The rod member has a first end and a second end. The first end of the rod member is attached to the resilient invaginated receiving member and the second end of the rod member is attached to a handle grip member. The handle grip member is able to mechanically actuate the resilient invaginated receiving member between the open position and the closed position in response to the movement of the handle grip member.

In another embodiment of the present invention, the resilient invaginated receiving member further defines two mating excrement engaging distal edges to facilitate removal of the excrement from a surface. Additionally, the two mating excrement engaging distal edges overlap when the resilient invaginated receiving member is in the closed position. Furthermore, to facilitate removal of the excrement from a surface, the edges of the two mating excrement engaging distal edges are serrated. The resilient invaginated receiving member may be manufactured such that it is in the normally open position.

The liner is generally disposed on the inner receiving surface of the resilient invaginated receiving member. To this end, the liner may be adhesively secured to the inner receiving surface of the resilient invaginated receiving member. Additionally, adhesive may be placed on the liner excrement engaging surface to retain the excrement on the excrement engaging surface. To help retain the adhesiveness of the adhesive on the excrement engaging surface during long periods of non-use of the device, the liner excrement engaging surface may further comprise a protective covering. To help reduce the time required to operate the device, a plurality of liners may be disposed on top of one another. In this regard, when the top most liner and the excrement is removed, the device is ready for use once the protective covering is removed. The top liner is peelably removable from a lower liner for disposal of the top liner. During operation of the device, the excrement is retained on the excrement engaging surface due to the adhesive on the excrement engaging surface.

To facilitate removal of the liner with the excrement contained therein, the liner further comprises at least one tab allowing the user to remove the liner and the retained excrement therein without touching any portion of the resilient invaginated receiving member. Additionally, the tab(s) is/are manufactured to protrude from the liner such that the tab is capable of tying the liner closed.

As discussed above, the first end of the rod members attached to the resilient invaginated receiving member and the second end of the rod member is attached to the handle grip member. To reduce the need for individuals to bend their knees and backs to remove excrement from a surface, the length of the rod member may be made adjustable in length. It may be adjustable in fixed incremental lengths or it may be telescoping.

The handle grip member may further comprise a holding member for manipulating the position of the resilient invaginated receiving member, and a trigger member for actuating the resilient invaginated receiving member between the open position and the closed position.

Furthermore, the device may comprise a shaft within the rod member, the shaft being attached to the trigger wherein the trigger pivots about an axis such that the shaft slides within the rod member. Additionally, a resilient invaginated receiving member being attached to the shaft, and a spring over the shaft within the rod member for translating the resilient invaginated receiving member to the open position.

In another embodiment of the present invention, a method of removing excrement from a surface comprises the steps of a) grasping a device having a resilient invaginated receiving member, a liner having an adhesive engaging surface, a rod member, and a handle grip member, b) positioning the resilient invaginated receiving member in an open position over the excrement, c) translating the resilient invaginated receiving member from the open position to a closed position incapsulating the excrement on the adhesive excrement engaging surface of the liner; and d) removing the liner with excrement retained on the liner excrement engaging surface.

In another embodiment of the present invention, the excrement retrieving device comprises a receiving member having two mating excrement engaging distal edges, a liner, a rod member, and a handle grip member. In particular, the two mating excrement engaging distal edges facilitate removal of the excrement from the surface. The liner is disposed external to the receiving member covering an excrement receiving end. The liner and the receiving member being cooperatively sized and configured to receive the excrement. The rod member has a first and a second end. The rod member first end is attached to the receiving member. The handle grip member is attached to the rod member second end. The movement of the handle grip member mechanically actuates the receiving member between the open and the closed position. The open position being the normal position of the receiving member.

The device may further comprise a discharge mechanism for facilitating removal of the liner from the receiving member. The discharge mechanism has a handle portion and a protrusion portion. The handle portion is slideably engaged to the rod member for sliding the discharge mechanism between a retracted position and an extended position. The retracted position being the normal position. Alternatively, at least one tab may be attached to the liner to facilitate removal of the liner from the receiving member.

The liner defines an excrement receiving surface. Adhesive may be disposed on about the outer perimeter of the excrement receiving surface for forming a sealed pouch. To protect the adhesive prior to actual use of the device, the adhesive may be covered by a protective covering. Alternatively, the adhesive may be continuously disposed on the excrement receiving surface for retaining substances therein and for forming a sealed pouch. To protect the adhesive prior to actual use of the device, the adhesive may be covered by a protective covering.

The device may further comprise a collapsible wire frame rotatably attached to the excrement engaging distal edges. The excrement engaging distal edges and the wire frame form an aperture at the excrement receiving end for providing support to the liner. Each excrement engaging distal edge has at least one stud. In this regard, the liner has at least one opening for hooking the liner onto each stud thereby securing the liner to the receiving member. Additionally, an arch is rotateable over the stud to disengage the liner from the stud.

The receiving member may further comprise a boss attached to the receiving member for securing the liner to the receiving member. The receiving member may be defined by two prongs having a first and second end. The prongs are rotateably attached at the prong first ends. The prongs have a concave configuration which are sized and configured to receive excrement.

In another embodiment of the present invention, a method of removing excrement from a surface is provided. The method comprises the steps of a) grasping a device having a receiving member, a liner having a tab, rod member, a discharge mechanism, and a handle grip member, b) positioning the receiving member over the excrement, c) translating a mid portion of the liner into the receiving member retaining a portion of the liner external to the receiving member by moving the handle grip member thereby removing the excrement from the surface, and d) removing the liner with the excrement retained therein.

### BRIEF DESCRIPTION OF THE DRAWINGS

These, as well as other features of the present invention, will become more apparent upon reference to the drawings wherein;

FIG. 1 is a front view of a user walking a dog and utilizing an excrement retrieving device to clean up after the dog with the resilient invaginated receiving member in the open position;

FIG. 2 is a front view of the resilient invaginated receiving member and the first end of the rod member with the resilient invaginated receiving member in the closed position with excrement retained therein;

FIG. 2a depicts a liner removed from the invaginated receiving member with excrement retained therein;

FIG. 3 is a front view of the excrement retrieving device with a liner depicted within the resilient invaginated receiving member as being conformed to the inner receiving surface and extending external to the invaginated receiving member;

FIG. 4 is a side view of the handle grip member in the actuated position when the resilient invaginated receiving member is normally closed;

FIG. 5 is a front view of the excrement retrieving device with the resilient invaginated receiving member in the normally closed position depicting the overlap of the two mating excrement engaging distal edges;

FIG. 6 is a side view of the excrement retrieving device;

FIG. 7 is a front view of the resilient invaginated receiving member and the first end of the rod member illustrating the plurality of liners disposed on top of one another where each liner extends external to the resilient invaginated receiving member;

FIG. 8 is a bottom view of the resilient invaginated receiving member in the open position having a plurality of liners and one tab protruding from each liner;

FIG. 9 is a front view of the excrement retrieving device with the resilient invaginated receiving member designed to be in its normally open position;

FIG. 10 is a side view of the handle grip member when the resilient invaginated receiving member is in the open position;

FIG. 11 is an orthographic view of an excrement retrieving device;

FIG. 12 is a orthographic view of the receiving member and liner;

FIG. 13 is front view of an excrement retrieving device with a discharge mechanism;

FIG. 14 is a side view of an excrement retrieving device with a discharge mechanism;

FIG. 15 is an orthographic view of the excrement retrieving device with the discharge mechanism in the extended position;

FIG. 16 is an orthographic view of the receiving member particularly depicting two mating excrement engaging distal edges;

FIG. 17 is an orthographic view of the receiving member particularly depicting a boss on each of the excrement engaging distal edges;

FIG. 18 is a front view of the excrement retrieving device particularly depicting the wire frame;

FIG. 19 is an orthographic view of the liner attached to the receiving member with adhesive disposed on the outer perimeter of the excrement engaging surface;

FIG. 20 is an orthographic view of the excrement retrieving device particularly depicting a liner attached to the receiving member through a system of openings in the liner hooked onto studs attached to the receiving member;

FIG. 21 is an orthographic view of the liner opening hooked onto the receiving member particularly depicting the operation of the arch;

FIG. 22 is an orthographic view of the liner disengaged by the arch;

FIG. 23 is an orthographic view of the excrement retrieving device with a discharge mechanism further comprising a fork; and

FIG. 24 is an orthographic view of the excrement retrieving device with the discharge mechanism in an extended position.

### DETAILED DESCRIPTION OF THE INVENTION

The detailed description set forth below in connection with the appended drawings is intended as a description of the presently preferred embodiment of the invention and is not intended to represent the only form in which the present invention may be constructed or utilized. The description sets forth the functions and the sequence of steps for constructing and operating the invention in connection with the illustrated embodiment. It is to be understood, however, that the same or equivalent functions and sequences may be accomplished by different embodiments that are also intended to be encompassed within the spirit and scope of the invention.

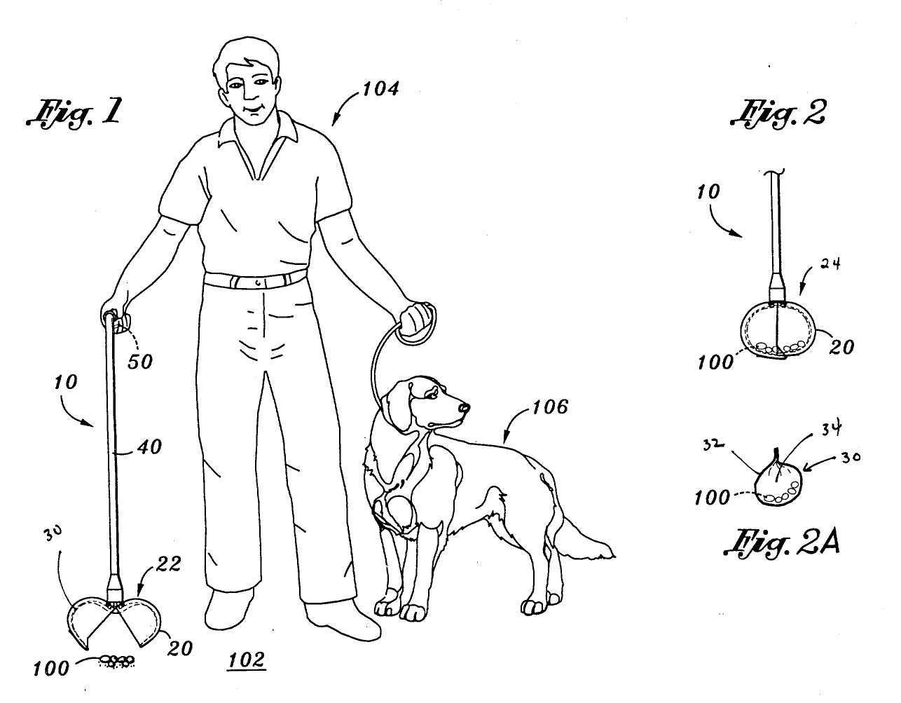

Referring to FIG. 1, the present invention relates to a substance retrieving device. The substance may be coagulated or it may be in a powder form. By way of example, and not limitation, the substance is an excrement of an animal. The device 10 can be manipulated from a distance greater than arm's length without the user 104 bending over to pick up excrement 100. To this end, the rod member 40 is fitted to the user's body size such that the resilient invaginated receiving member 20 will contact the ground 102 when the user 104 is grasping the handle grip member 50 comfortably at the intended position. Typically, the user 104 is in the upright position while grasping the handle grip member 50 comfortably from the waist with the opening of the resilient invaginated receiving member 20 contacting the ground 102 over the excrement 100. In this position, the user 104 squeezes the handle grip member 50 1) translating the resilient invaginated receiving member 20 from the open position 22 to the closed position 24, as shown in FIG. 2, 2) encapsulating the excrement 100 within the resilient invaginated receiving member 20 and the liner 30, and 3)sealing the excrement 100 within the liner 30 for quick removal of the liner 30 with retained excrement 100 thereon. Hence, the user 104 is able to 1) clean up after his pet 106 without bending over and 2)perform the clean up task at a distance greater than arm's length.

As shown in FIG. 1, the excrement retrieving device 10 comprises a resilient invaginated receiving member 20, a liner 30, a rod member 40, and a handle grip member 50.

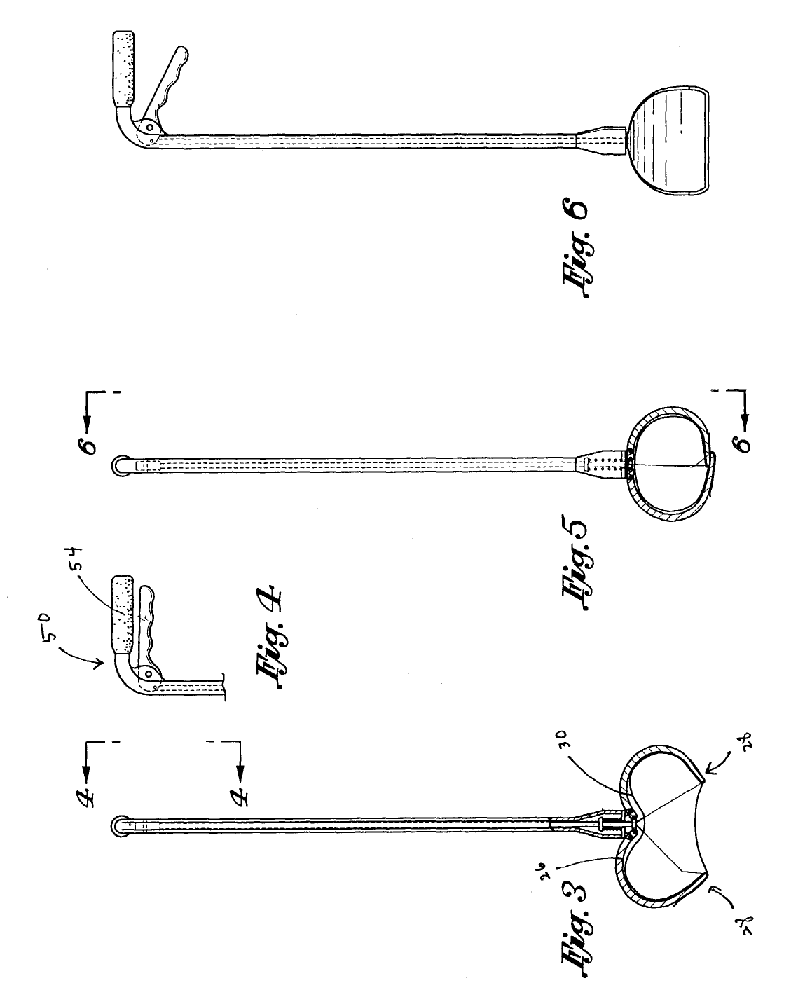

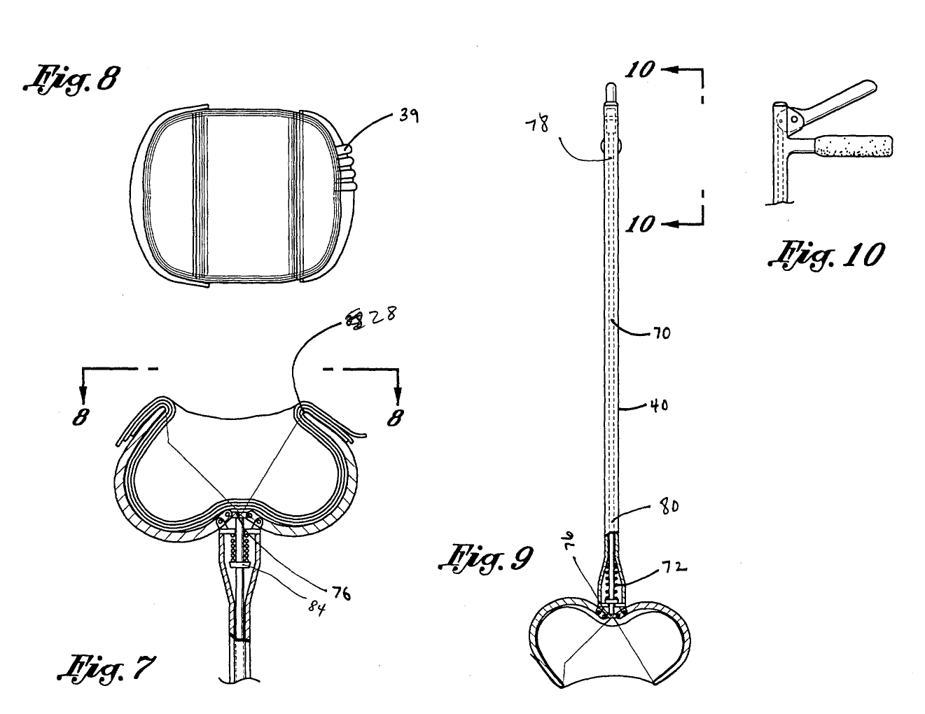

The resilient invaginated receiving member 20 is deformable between an open position 22, as shown in FIG. 3,and a closed position 24, as shown in FIG. 2. The resilient invaginated receiving member 20 is made from a resilient paper or plastic material. The resilient invaginated receiving member 20 is translated to the open position 22 from the closed position 24 when the handle grip member 50 is squeezed. In the open position 22, the resilient invaginated receiving member 20 is ready to receive the excrement 100. In picking up the excrement 100, the user 104 will press the resilient invaginated receiving member 20 slightly against the ground 102 to deform the edges of the opening to fit the ground's contour. As such, when the opening is translated back to the closed position 24, the two mating excrement engaging distal edges 28, as shown in FIG. 3, of the resilient invaginated receiving member 20 will scoop the excrement 100 into the resilient invaginated receiving member 20. When the resilient invaginated receiving member 20 is in the closed position 24, the two mating excrement engaging distal edges 28 overlap to form a cavity within the resilient invaginated receiving member 20. To further facilitate the removal of excrement 100 from a surface, the edges may be formed into various shapes. For example, as shown in FIG. 6, the profile of the edge may be flat. Additionally, the edges may be wedge shaped, serrated, or a combination thereof.

Referring to FIG. 3, the resilient invaginated receiving member 20 does not contact the excrement 100 because a liner 30 is placed between the excrement 100 and the resilient invaginated receiving member 20 providing a barrier between the excrement 100 and the resilient invaginated receiving member 20. The liner 30 is fabricated from a pliable paper or plastic material that is contoured to the shape of the inner receiving surface 26.

The liner 30 may be retained on the inner receiving surface 26 of the resilient invaginated receiving member 20 with an adhesive, at least one tab 39, the invaginated shape of the receiving member 20, or by a combination thereof. An adhesive may be placed between the liner mating surface 32 and the inner receiving surface 26 to secure the liner 30 to the inner receiving surface 26. The adhesive maybe sprayed on, taped on, or otherwise applied to either, or both mating surfaces before the liner 30 is placed on the inner receiving surface 26. As discussed below, a tab(s) 39 may retain the liner 30 on the receiving member 20. Lastly, as shown in FIG. 3, the opening of the receiving member 20 is smaller than the widest portion of the contoured liner 30. As such, the width of the liner 30 can mechanically retain the liner 30 within the receiving member 20.

The surface of the liner 30 that contacts the excrement 100 is called the excrement engaging surface 34. This surface 34 may have adhesive applied thereon to 1) facilitate removal of the excrement 100 off of a surface, 2) provides structure to the liner so as to close the liner 30 with excrement 100 retained therein, or 3) serve a combination of the purposes. In particular, the adhesive may be applied evenly throughout the surface or it may be placed on the outer perimeter portion of the liner or the inner portion of the liner. First, the adhesive on the excrement engaging surface 34 facilitates removal of the excrement 100 off of a surface 102 by adhering the excrement 100 to the liner 30. In this regard, the user is given a greater degree of freedom in removing the excrement 100 from a surface 102. Second, the adhesive provides structure to the liner 30 so as to close the liner 30 with excrement retained therein. In this regard, the receiving member 20 folds the liner 30 in half and the distal edges 28 apply pressure to the outer perimeter portion of the liner 30 so as to close the liner 30 with excrement 100 retained therein. Alternatively, the liner 30 may extend outwardly from the resilient invaginated receiving member 20 sufficiently such that the outer edges of the liner 30 does not contact the excrement 100. As such, the adhesive on the excrement engaging surface 34 may be folded on top of each other, after the receiving member 20 is translated to the closed position 24, to provide a method of closing the liner 30.

At least one tab 39 may be formed on the liner 30. The tab(s) 39 may serve to 1) secure the liner 30 to the resilient invaginated receiving surface, 2) provide a means of lifting an adhesively peelable liner 30 off the resilient invaginated receiving member 20, 3) provide a mechanism to seal the liner 30 when the liner 30 is removed with excrement 100 retained therein from the resilient invaginated receiving member 20, or 4) serve as a combination thereof. In securing the liner 30 to the resilient invaginated receiving member 20, the tab 39 is formed on the liner 30 starting within the resilient invaginated receiving member 20 and extends outwardly from the liner 30 and the resilient invaginated receiving member 20 in a manner such that the tab 39 does not interfere with the removal of excrement 100 from a surface. The tab(s) 39 is formed from a pliable material, for example, a ductile metal, such that when the tab(s) 39 is/are bent around the thickness of the resilient invaginated receiving member 20, the tab(s) 39 secure the liner 30 to the resilient invaginated receiving member 20. In this respect, it is not necessary to use adhesives or any other type of securement method in order to prevent the liner 30 from being inadvertently removed from the resilient invaginated receiving member 20.

Additionally, the tab(s) 39 can provide a method of peeling a liner 30 off of a resilient invaginated receiving member 20 that is adhesively secured to each other by providing the user a small handle to begin the peeling process. The tab(s) 39 extend external to the liner 30 and the resilient invaginated receiving member 20 sufficiently such that the tab(s) 39 will not contact the excrement 100. As such, the user does not come into contact with the excrement 100 when removing the liner 30 from the receiving member 20.

Furthermore, the tab(s) 39 can provide a method of closing the liner 30 after the liner 30 with retained excrement 100 therein has been removed from the resilient invaginated receiving member 20. The tab(s) 39 may be formed such that the tab(s) 39 protrudes from the liner 30 sufficiently so as to allow the user to wrap the tab 39 around the opening of the liner 30 thereby sealing the liner 30.

Referring to FIG. 7, a plurality of liners 38 attached to the inner receiving surface 26 may be placed on top of one another. Each liner 30 has an adhesive on the excrement engaging surface 34, at least one tab 39, and a protective covering. In this respect, upon removal and disposal of a top liner 30, the next lower liner 30 is ready for use after the removal of its protective covering.

Referring to FIG. 8, as shown, the tab(s) 39 are aligned next to each other such that the user does not have to separate the tabs 39 when peeling the liner 30 from the receiving member 20.

With a liner 30 or a plurality of liners 38 placed on the inner receiving surface 26 of the resilient invaginated receiving member 20, the resilient invaginated receiving member 20 places the excrement 100 within the liner 30 when the resilient invaginated receiving member 20 is translated from the open position 22 to the closed position 24. Typically, as seen in FIG. 1, a user 104 will place the resilient invaginated receiving member 20 so as to completely cover the excrement 100. As seen in FIG. 2, the edges of the resilient invaginated receiving member 20 scoop the excrement 100 into the liner 30 and the excrement 100 is sealed within the liner 30 when the resilient invaginated receiving member 20 is translated from the open position 22 to the closed position 24. To further aid the resilient invaginated receiving member 20 in scooping the excrement 100 into the liner 30, an adhesive is placed on the excrement engaging surface 34 to adhere the excrement 100 to the liner 30. Additionally, the liner 30 contains a protective covering 36, which is removable from the excrement engaging surface 34. The protective covering 36 is a plastic film or other material that is peelable from the adhesive on the excrement engaging surface 34 and does not absorb the adhesive. The protective covering serves to cover the adhesive on the excrement engaging surface 34, such that the contaminants will not destroy the adhesive property of the adhesive when the liner 30 is not in use.

When the resilient invaginated receiving member 20 is translated back to the open position 22, the liner 30 or top liner 30 is removed from the resilient invaginated member 20 or the next lower liner 30 for convenient disposal of the excrement 100. The liner 30 with retained excrement 100 therein is removed from the resilient invaginated receiving member 20. Preferably, the excrement 100 is removed by holding the resilient invaginated receiving member 20 over a proper disposal container (i.e., trash can) and then removing the liner 30 from the resilient invaginated receiving member 20 with the tab 39, then closing the liner 30 with the tab 39 or the adhesive which is placed on the excrement engaging surface 34. The liner 30 and the excrement 100 contained thereon are then properly disposed of in the disposal container. Hence, the excrement 100 is removed from the resilient invaginated receiving member 20 without the user 104 having to bend over or smell the excrement 100.

The excrement retrieving device 10 may be manufactured with various fixed rod member lengths such that a user 104 may select the optimal rod length for that particular user 104.

The rod member 40 may be adjustable in intervals of fixed lengths. For example, the rod member 40 may comprise two cylindrical tubes wherein a first tube is collapsible within a second tube. The second tube having a plurality of holes along its length. A first tube having an outer diameter slightly smaller than the inner diameter of the second tube and a protruding spring loaded pin slightly smaller in diameter than the plurality of holes along the length of the second tube. As the first tube is placed in the second tube, the pins will click into one hole of the plurality of holes along the length of the second tube locking the two tubes in a fixed length. The rod member 40 may be shortened by depressing the spring loaded pin and sliding the pin into the next hole.

The rod member 40 may be telescoping. For example, the rod member 40 will have a first pipe, a second pipe, and a tapered knurled nut. The first pipe will have a threaded end with slots cut along the length of the first pipe. When the second pipe is slid into the first pipe, the tapered knurled nut is tightened constricting the first pipe threaded end onto the circumference of the second pipe thereby securing the second pipe in place. With this type of adjustment, the user 104 may adjust the length of the rod member 40 according to the user's height.

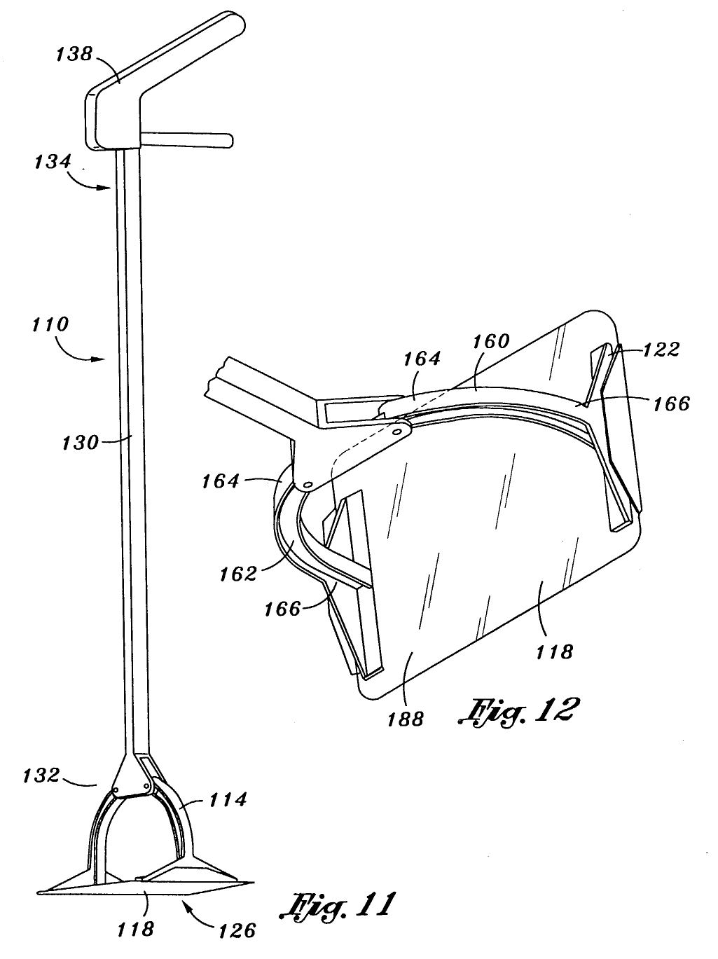

Referring to FIG. 4, the handle grip member 50 is attached to the rod member second end 44. The handle grip member 50 comprises a holding member 54 and a trigger 52 member that mechanically actuates the resilient invaginated receiving member 20 between the closed position 24 and the open position 22 when the user 104 squeezes the handle grip member 50. As shown in FIG. 3, the resilient invaginated receiving member 20 may be manufactured to be in a normally closed position 24, or as shown in FIG. 9, it may be designed to be in a normally open position 22.

As shown in FIGS. 9 and 10, the trigger 52 rotates about a pivot point with one end of the trigger 52 rotatably connected to a shaft 70 that slides within the rod member 40 in response to the movement of the trigger 52. At the end of the rod member 40 where the resilient invaginated receiving member 20 is attached, a compression spring 72 is used to apply a force to the shaft 70 which applies a force to the pivot point of the resilient invaginated receiving member 20. In conjunction with the force created by the spring 72, two opposing forces react upon the resilient invaginated receiving member 20 thereby maintaining the resilient invaginated receiving member 20 in the open position. As shown in FIG. 10, the resilient invaginated receiving member 20 translates to the closed position 24 when the trigger 52 is squeezed.

Furthermore, in FIG. 9, the shaft 70 has a first end 78 and a second end 80. The first end 78 is pivotally engaged to the handle member 50. The second end 80 may be engaged to the link 76 or may merely contact the link surface. In particular, if the shaft second end 80 merely contacts the link 76, then this provides for easy removal of the receiving member 20 from the device 10 in that the receiving member 20 has to be detached from one member, namely the rod member 40 and not from two members, namely the rod member 40 and the shaft 70. In this regard, a shaft 70 that merely contacts the link surface facilitates switching or removal of variously configured receiving members 20 from the device 10. By way of example and not limitation, the receiving member 20 may have serrated or wedge shaped excrement engaging distal edges 28. In this regard, a receiving member 20 with a serrated edge may be switched out for a receiving member 20 with a wedge. If the shaft second end 80 is engaged to the link 76, then the engagement may be non-integral in that the link 76 is detachable from the rod member 40. This also facilitates removal of the receiving member 20 in that only one connection needs to be detached, namely the connection between the shaft 70 and the link 76 instead of two connections, namely the two connections attaching the link 76 to the receiving member 20, as shown in FIG. 9.

Alternatively, the shaft 70 may be directly attached to or in contact with the receiving member 20 at a single point or edge without any intermediate link 76. In this regard, the greatest possible torque is created on the receiving member 20 in response to movement of the handle member 50.

The configuration of the rod member 40 and the shaft 70 allows a user to configure the excrement retrieving so that the receiving member is either in the normally closed or normally open position as shown in FIGS. 7 or 9, respectively. In particular, the spring is placed either below or above the spring base 84.

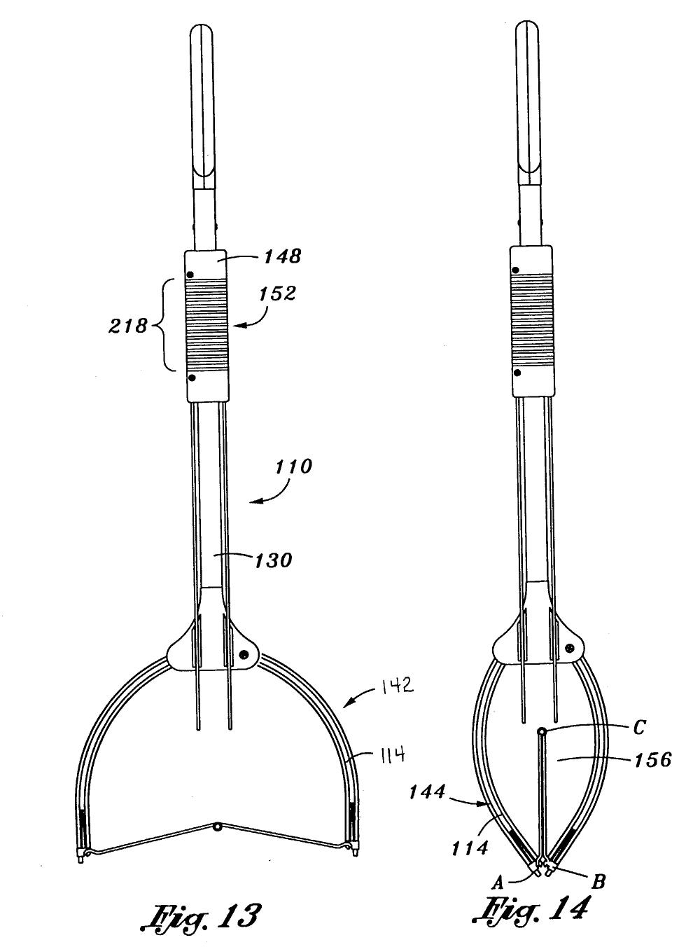

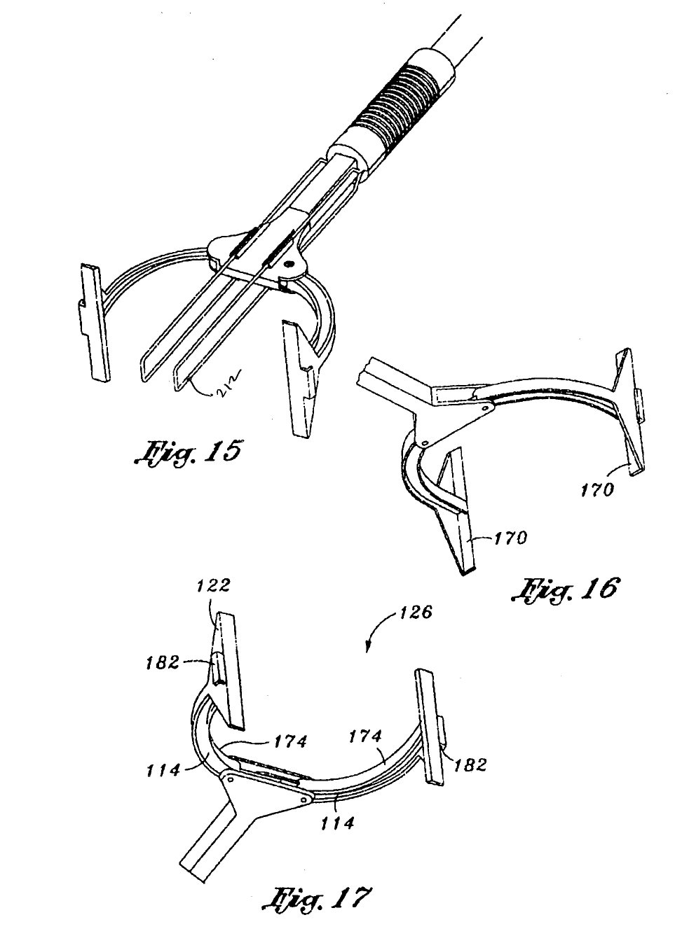

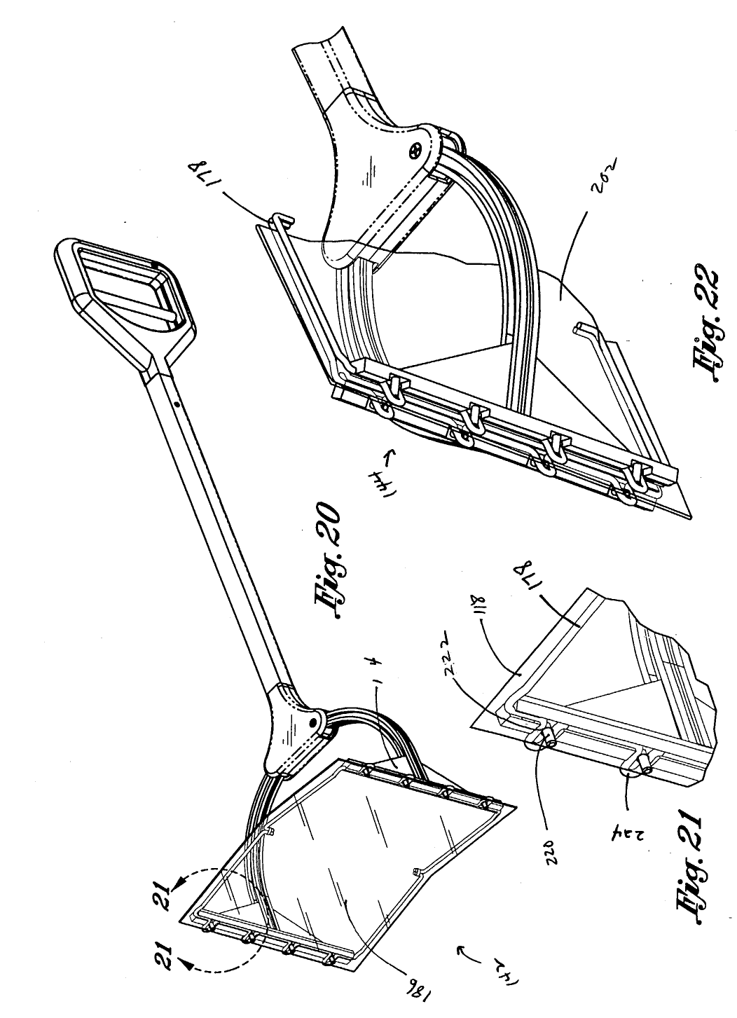

In a second embodiment of the present invention, a substance retrieving device 110 is depicted in FIG. 11. The features of the second embodiment of the present invention are identical to the features of the prior embodiment of the present invention except as modified in the following discussion of the second embodiment. The substance may be coagulated or it may be in a powder form. By way of example and not limitation, the substance is an excrement 100 of an animal. The device 110 has a receiving member 114, a liner 118 disposed on the outside edges 122 of the receiving member opening 126, a rod member 130 connected at its first end 132 to the receiving member 114 and connected at its second end 134 to a handle grip member 138, as shown in FIGS. 11-12. The handle grip member 138 mechanically translates the receiving member 114 between an open position 142 and a closed position 144 in response to movement of the handle grip member 138. The open position 142 is shown in FIG. 13. The closed position 144 is shown in FIG. 14. Optionally, as shown in FIG. 13, the device 110 has a discharge mechanism 148 that slides along the rod member 130 for removing the liner 118 (not shown) from the receiving member 114 by sliding the discharge mechanism 148 to an extended position 150 from a retracted position 152. The liner 118 is shown on FIG. 19. The extended position 150 is shown in FIG. 15. A detailed discussion of each of the elements of the invention will now be discussed.

The handle grip member 138 is equivalent to the previously described handle grip member 50. The rod member 130 is equivalent to the previously described rod member 40.

The receiving member 114 has two positions, namely the open position 142 and the closed position 144, as shown in FIGS. 13 and 14, respectively. The closed position 144 defines an inner cavity 156, as shown in FIG. 14. The normal position of the receiving member 114 may be either the closed 144 or the open position 142. In this regard, movement of the handle grip member 138 translates the receiving member 114 from its normal position to either its open or closed position 142, 144. The structure and theory for translating the receiving member 114 between the closed and open position 144, 142 is identical to the previously described mechanism for opening the receiving member 20.

The receiving member 114 has two prongs 160, 162 wherein each prong 160, 162 has a first end 164 and a second end 166, as shown in FIG. 12. Each prong 160, 162 is rotatably connected to each other at the prong first end 164. The prongs 160, 162 rotate about this first end 132 when the receiving member 114 is translated between the open and closed position 142, 144. Each prong second end 166 further defines an excrement engaging distal edge 170. The excrement engaging distal edges 170 are generally long flat surfaces that facilitate scraping the excrement from the surface. More specifically, when the receiving member 114 is translated from the open position 142 to the closed position 144, the excrement engaging distal edges 170 engage the excrement from both sides forcing the excrement into the inner cavity 156 formed by the receiving member 114 and the liner 118.

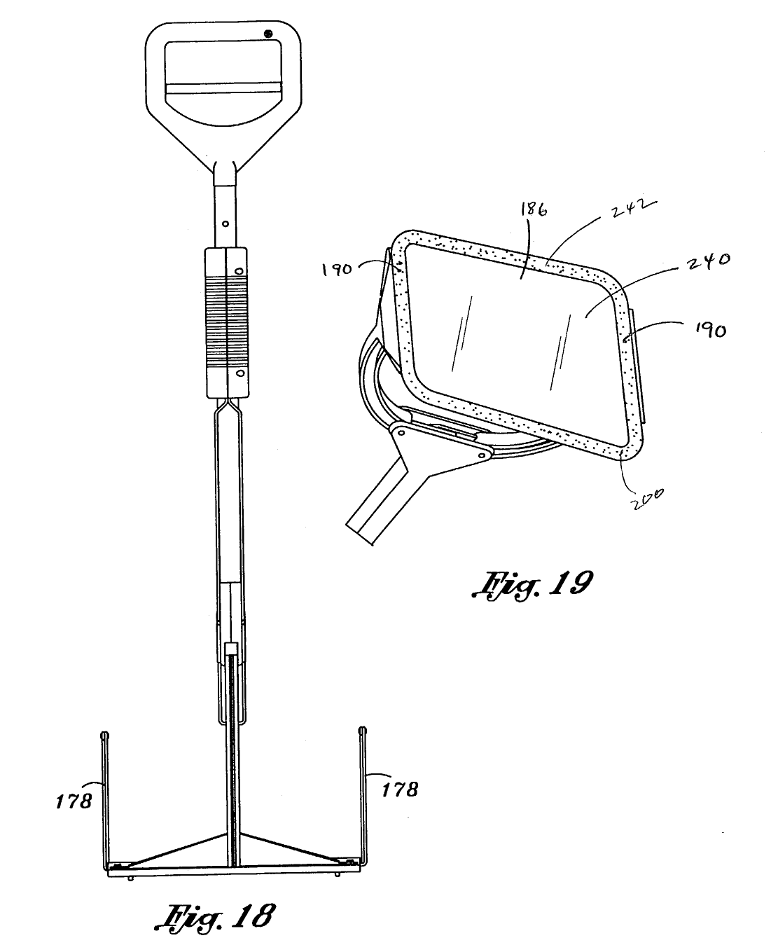

The prongs 160, 162 are generally concave so as to form the inner cavity 156 when the receiving member 114 is in the closed position 144, as shown in FIG. 14. Referring to FIG. 17, the concave side 174 of the first prong 160 is directed toward the concave side 174 of the second prong 162 to form that inner cavity 156. In this regard, the receiving member 114 is sized and configured to receive excrement. [00791 Optionally, the receiving member 114 may further have a pair of wire frames 178, as shown in FIG. 13, 14, 18, and 20-22. Each wire frame 178 is rotatably engaged to a distal ends of the excrement engaging distal edges 170. One end of the wire frame 178 is rotatably connected to the outer end of one of the excrement engaging distal edges at pivot A as shown in FIG. 14. The other end of the wire frame is rotatably connected to the outer end of the other excrement engaging distal edges at pivot B. The wire frame 178 is able to collapse at its mid point C when the receiving member 114 is translated to the closed position 144.

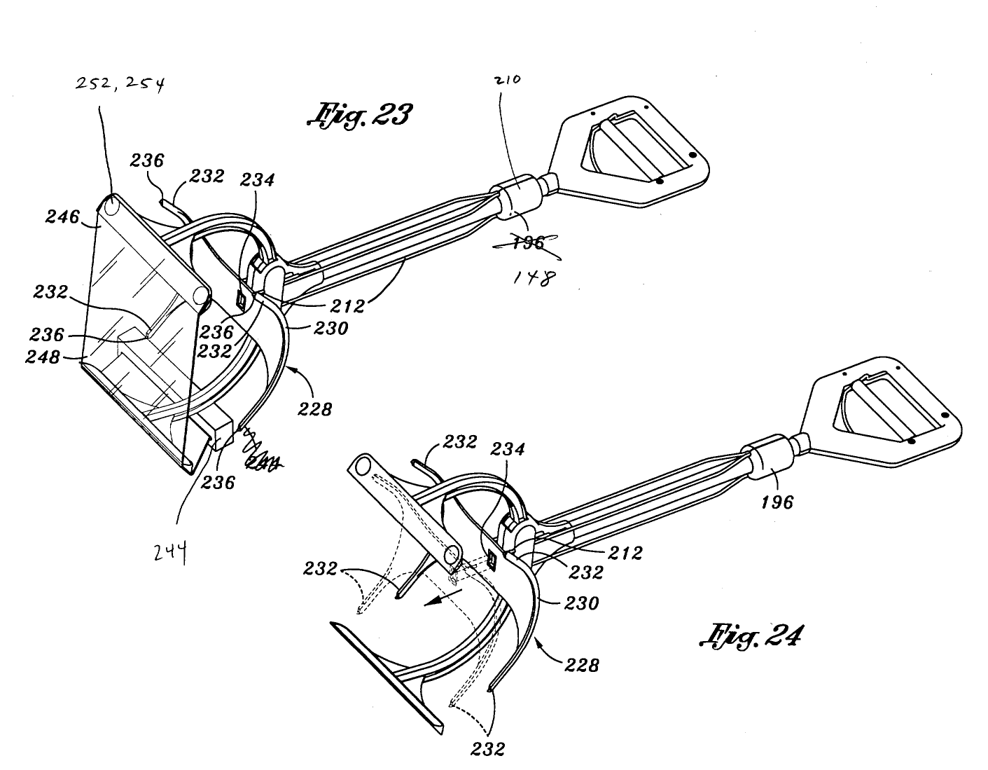

In this regard, the wire frame 114 and the excrement engaging distal edges 170 form a four sided opening 126 when the receiving member 114 is in the open position 142 as shown in FIG. 20. When the receiving member 114 is translated to the closed position 144, the wire frame 178 collapses and the excrement engaging distal edges 170 mate as shown in FIG. 22.

The liner 118 is disposed externally in relation to the receiving member 114 at the opening 126 thereof when the receiving member 114 is in the open position 142, as shown in FIG. 20. In this position, the liner 118 does not invade the inner cavity 156. When the receiving member 114 is translated from the open position 142 to the closed position 144, a mid-portion of the liner 118 is transferred to the inner cavity 156 of the receiving member 114. In the regard, the liner 118 and the receiving member 114 are cooperatively sized and configured to receive the excrement. Additionally, the liner 118 provides a barrier between the excrement and the receiving member 114. More specifically, the liner 118 prevents physical contact between the excrement engaging distal edges 170 and the excrement. As such, the device 110 is kept sanitary. Furthermore, the liner 118 forms a pouch 202 when the receiving member 114 is translated to the closed position 144. In particular, the receiving member distal edges 170 engage the excrement 100 and scoop the excrement 100 from a surface 102 into a liner 118 as the receiving member 114 is translated to the closed position 144. The distal edges 170 applies pressure to an adhesive 200 located at a liner outer perimeter portion 242 thereby forming a pouch 202 when the receiving member 114 has reached the closed position 144. When the receiving member 114 is translated to the open position 142, the liner 118 maintains the excrement 100 within the pouch 202. The pouch 202 may naturally disengage the receiving member 114 or it maybe forced off through a discharge mechanism 196.

Alternatively, the liner 118 may be formed to fit the excrement engaging distal edges 170. More specifically, the liner 118 is attached to the outside of the receiving member 114, then the liner 118 is folded into the inner cavity 156 and behind the excrement engaging distal edge 170. In this regard, the excrement engaging distal edges 170 scrape and lift the excrement 100 into the inner cavity 156.

Optionally, the receiving member 114 may have at least one boss 182 on each outside edge 122 of the receiving member opening 126, as shown in FIGS. 16 and 17. The boss 182 provides an area on the receiving member 114 to attach the liner 118. For example, a clip may be attached to the boss(es). In this regard, the liner 118 will be clipped to each boss 182 securing the liner 118 to the receiving member 114.

Adhesive may be placed on the boss(es) 182 or on the portion of the liner receiving member surface 188 that contacts the boss(es) 182. In this manner, the adhesive secures the liner 118 to the receiving member 114. The liner has two surfaces, namely an excrement receiving surface 186 and the receiving member surface 188, as shown in FIGS. 19 and 12, respectively. The excrement receiving surface 186 contacts the excrement or substance during the removal of the excrement from the surface. The receiving member surface 188 is the opposite side of the liner 118 from the excrement receiving surface 186.

The adhesive is placed on the receiving member surface 188. More specifically, the adhesive would be placed at the interface of the boss 182 and the liner 118. Additionally, the adhesive is positioned on the receiving member surface 188 so that the liner 118 is taut when engaged to the receiving member 114. Optionally, markings may be placed on the liner to facilitate the proper and accurate placement of the liner 118 onto the receiving member 114.

Functionally, the adhesive must be able to withstand the forces required to manipulate the device 110 while receiving excrement from the surface. Additionally, the adhesive should allows the liner to be easily peeled, pulled, or pushed off from the receiving member 114.

Alternatively, the boss 182 may be eliminated from the receiving member 114 and a system of hook and loop fasteners 252, 254 utilized to attach the liner 118 to the receiving member 114. In this regard, an array of hooks will be located on the external side of the receiving member 114, and an array of loops will be located on a portion of the liner 118 as shown in FIG. 23. More specifically, the loops 254 are placed on the portion of the liner 118 that attaches to the receiving member 114 on its receiving member surfacel88. In this regard, the liner 118 is removeably attachable to the receiving member 114.

The hook and loop fasteners 252,254 may also be placed on the outer perimeter portion 242 of the liner 118 on the excrement receiving surface 186 to form the pouch 202 as shown in FIG. 22. In particular, the one lateral edge 190 will have attached thereto a strip of hooks 252. A mating lateral edge 190 will have attached thereto a strip of loops 254. When the distal edges 170 mate, the hooks 252 and loops 254 attach together to form the pouch 202. Alternatively, the system of hook and loop fasteners 252, 254 may be placed around the whole liner outside perimeter portion 242 so as to form a pouch 202 when the receiving member 114 is translated to the closed position 144.

Adhesive 200 may also be placed on the outer perimeter 242 of the excrement receiving surface 186, as shown by the hatched portion in FIG. 19. The adhesive 200 is placed thereon so that the perimeter 242 will form the edges of the pouch 202 to encapsulate the excrement 100 when the receiving member 114 is translated to the closed position 144. In this regard, the wire frames 178 and the excrement engaging distal edges 170 form the liner 118 into a pouch 202 sealed by the adhesive 200 to enclose the excrement within the liner 118. Since the outer perimeter 242 is covered with adhesive 200, the adhesive 200 will tend to form a pouch 202 adhesively enclosing the excrement therein. Alternatively, the adhesive 200 may be placed intermittently or continuously along the outer perimeter 242 or throughout the excrement receiving surface 186. In this regard, the adhesive 200 placed on the outer perimeter of the excrement receiving surface 186 facilitates retainment of the excrement within the liner 118. The adhesive 200 placed throughout the excrement receiving surface 186 facilitates retainment of the excrement, or in the alternative, powder substances, onto the excrement receiving surface 186. Alternatively, the excrement receiving surface 186 may be free of any adhesive.

The portions of the liner 118 where adhesive 200 is placed may be covered by a protective covering 206. The protective covering 206 is used to prevent unwanted substances from adhering to the adhesive 200 which would thwart the purposes of the adhesive 200 where the purposes of the adhesive 200 are discussed above. In this regard, the protective coverings 206 are positioned on the liner 118 so that the user may remove that protective covering 206 immediately before use of the liner 118. Each liner 118 may have its own set of protective coverings 206 covering the adhesive 200 thereon.

The adhesive 200, wire frame 178, receiving member 114, and the liner 118 work in conjunction to receive excrement. When the liner 118 and the receiving member 114 translates to the closed position 144, the adhesive 200 on the excrement receiving surface 186 of the liner 118 seals the liner 118 to form a pouch 202. The excrement engaging distal edges 170 and the wire frame 178 seal the adhesive 200 located around the perimeter of the excrement receiving surface 186. If the wire frame 178 is not utilized then the user may apply pressure to those portions which the wire frame 178 would have applied pressure to form a pouch 202.

To facilitate removal of the liner 118 from the receiving member 114, the liner 118 may have at least one tab 39 protruding from the liner 118 and the receiving member 114 when the receiving member 114 is in the closed position 144. In this regard, the user may grasp the tab(s) 39 and pull/peel the liner 118 off the receiving member 114. A plurality of liners 118 may be disposed on top of one another. In this regard, the liner 118 does not need to be reloaded into the receiving member 114 after each use of the device 110. Rather, the device 110 will be ready for another use.

Alternatively, the liner 118 may be removed from the receiving member 114 automatically as the receiving member 114 is translated from the open position 142 to the closed positionl44, as shown in FIGS. 20-22. In this regard, the liner 118 will be attached to the receiving member 114 through the use of studs 220 attached to the receiving member 114 that behave as hooks so that holes or slits 222 at the lateral edges 190 of the liner 118 may be hooked onto the receiving member studs 220. The liner holes are shown engaged to the studs 220 in FIGS. 20-21 Each receiving member distal edge 170 will have at least one stud 220. The liner 118 will have an equal number of hole(s) or slit(s) 222 that correspond to the number of studs 220.

To apply the liner 118 to the receiving member 114, the user will squeeze the handle member 138 thereby slightly closing the receiving member 114. The user will slide the liner hole(s) 222 onto the studs 220, then release the handle member 138 thereby opening the receiving member 114. Now, the liner 118 will be taut on the receiving member 114.

After the liner 118 is attached to the receiving member opening 126, the receiving member 114 is translated to the closed position 144 thereby encapsulating excrement within the receiving member 114 and liner 118. Simultaneously, arches 224 rotate in conjunction with the receiving member 114 to push/dislodge the liner 118 from the studs 220, as shown in FIG. 22. In particular, the arches 224 are formed as part of the wire frame 178, as shown in FIG. 21. When the receiving member 114 is closed or opened, the wire frame 178 collapses or opens thereby rotating the arches 224 in relation to the studs 220. The arches 224 are positioned close to the studs 220 so that the arches 224 will push/dislodge the liner 118 from the stud(s) 220. Furthermore, the distal edges of the receiving member 114 and the wire frame 178 provide pressure to adhesive located at the periphery of the excrement receiving surface 186 to form a seal about the excrement when the receiving member 114 is translated to the closed position 144. In this regard, when the user has completely translated the receiving member 114 to the closed position 144, the liner 118 is dislodged from the receiving member 114 and is ready for disposal, as shown in FIG. 22.

Alternatively, the liner 118 may be removed from the receiving member 114 with a discharge mechanism 148 that is slideably engaged to the rod member 130, as shown in FIG. 23. A discharge mechanism 148 may be slideably engaged to the rod member 130. The discharge mechanism 148 has a handle portion 210 and a protrusion portion 212 attached at one end of the handle portion 210. The discharge mechanism 148 has a retracted position 152, as shown in FIG. 23 and an extended position 150, as shown by phantom lines in FIG. 24. In the retracted position 214, the handle portion 210 is closest to the handle grip member 138 and the protrusion portion 212 will not interfere with the functioning of the receiving member 114 and the liner 118 to scoop up excrement 100. Simply put, the discharge mechanism 148 does not interfere with the translational movement of the receiving member 114, yet is able to discharge the liner 110 and/or substances contained therein from the receiving member 114 after such translational movement. I.e., closing and opening of the receiving member 114.

When the user slides the discharge mechanism 148 to the extended position 150, the protrusion portion 212 invades the inner cavity 156 of the receiving member 114 thereby discharging the liner 118 and its contents from the receiving member 114 as shown in FIG. 24. The handle portion 210 of the discharge mechanism 148 may have grips 218 on its outer surfaces to facilitate easy grasping of the handle portion 210, as shown in FIG. 13.

Referring to FIG. 23, the discharge mechanism 148 may further comprise a fork 228. The fork 228 defines abase portion 230 and four prongs 232. The base portion 230 is attachable to the protrusion portion 212. In particular, the fork base portion 230 is attached to the protrusion portion 212 through a clip 234. As shown in FIG. 15, the distal end of the protrusion portion 212 has two U-shaped wire frames. The base portion 230 has a receiving or female counterpart or clip 234 that frictionally engages the two U-shaped wire frames. In this regard, the fork 228 is retained on the protrusion portion 212. By way of example and not limitation, the attachment may alternatively be accomplished with hook and loop fasteners 252, 254 or screws. Hook and loop fasteners 252, 254 are sold under the trademark VELCRO.

The prongs 232 extend out from the fork base 230 to a respective corner of the liner 118. In particular, the base 230 extends parallel to the distal edges 170. The prongs 232 are attached to the distal end of the base 230 and are oriented toward the distal edges 170. This configuration allows the receiving member prong 160, 162 to translate freely without interference from the fork 228. In this regard, the receiving member prong 160, 162 may enter the inner cavity of the fork 228 when the receiving member 114 is translated to the closed position 144. After the liner 118 has formed a pouch 202, the discharge mechanism 148 is actuated in which the prong tips 236 traverse near the distal edges 170 of the receiving member 114. The prong tips 236 travel sufficiently close to the distal edges 170 to create a sufficient amount of shear force to dislodge the liner 118 from the receiving member 114 regardless of the attachment means used to hold the liner 118 to the receiving member 114.

The discharge mechanism 148 when translated to the extended position 216 applies a force to the liner lateral edges 190. In this regard, a sufficient amount of pressure is applied to the liner 118 so as to disengage the liner 118 from the receiving member 114. Even if the liner 118 is not engaged to the receiving member at all four corners of the liner 118, the fork 228 is able to apply a sufficient amount of pressure to the liner 118 to disengage the liner 118 from the receiving member 114.

In general, the clinging strength formed by the adhesive 200 or hook and loop fasteners 252,254 between the receiving member surface 188 and the receiving member distal edge 170 is sufficient to hold the liner 118 alone thereon unless excrement is encapsulated within a pouch 202 formed by the liner 118. Furthermore, the clinging strength therebetween is not equal at the two distal edges 170. In particular, the clinging strength between the liner 118 and one of the distal edges 170 is stronger than the other. In this regard, the pouch completely disengages the distal edges when excrement is retained in a pouch 202 formed by the liner 118. However, in the situation where the pouch remains on one of the distal edges after the liner 118 encapsulates the excrement and the receiving member has been translated to the open position, a discharge mechanism 148 disengages the pouch. In relation to the adhesive, adhesives similar to the adhesives used on sticky note pads sold under the trademark POST IT may be used. During use, when the receiving member 114 is translated to the closed position 144 thereby encapsulating excrement 100 therein and translated back to the open position 142, the pouch 202 formed from the liner 118 should disengage the receiving member 114 due to the gravitational forces derived from the excrement based on a view that the adhesive is not strong enough to hold the liner thereon. However, if the pouch 202 has not disengaged the receiving member 114 then the user may operate a discharge mechanism 148 designed to forceably disengage the pouch 202 from the receiving member 114. In this regard, the shear forces created by the discharge mechanism 114 at the interface between the distal edge 170 and excrement receiving surface 186 is greater than the clinging strength therebetween created by the adhesive 200 or hook and loop fasteners 252, 254.

Additionally, the adhesive 200 placed on a central portion 240 of the liner excrement receiving surface 186 is sufficient to hold excrement 100 thereon. In other words, the clinging strength of the adhesive 200 placed thereon should be sufficiently strong to withstand the full gravitational forces of the excrement 100.

The adhesive 200 placed on the outer perimeter 242 of the liner 118 has a cling strength capable of clinging together or retaining the liner's pouch formation when the receiving member 114 is translated back to the open position 142. In other words, the cling strength between the lateral edges 190 of the liner 118 due to the adhesive 200 is greater than the forces created by the adhesive 200 or hook and loop fasteners 252, 254 between the distal edges 170 and the receiving member surface 188 when the receiving member 114 is translated to an open position 142. In this regard, the liner 114 being formed into a pouch 202 retains the pouch formation even when the receiving member 114 is translated to the open position 142. Ideally, the pouch 202 should disengage the receiving member 114 due to the gravitation forces of the excrement 100 alone. However, if it has not, then the discharge mechanism 148 is utilized to forceably disengage the pouch 202 therefrom.

As discussed above, the receiving member surface 188 may have adhesive placed thereon to attach the liner 118 to the receiving member 114. Additionally, the excrement receiving surface 186 may have adhesive thereon. The adhesive thereon is not required for the device 110 to remove excrement from a surface. The adhesive merely facilitates retainment of excrement in the pouch.

In relation to the application of the liner 118 to the receiving member 114, optionally, a liner dispenser 244 may be attached to the excrement retreiving device 110 as shown in FIG. 23. The liner dispenser 244 conveniently dispenses liners 118 when needed. The liner dispenser 244 is enclosed in a box which is attached to the excrement retreiving device 110. One liner 118 may be pulled out from the liner dispenser 244 at a time. Normally, the liner dispenser 244 is loaded with a plurality of liners 118. In the preferred embodiment, the liner dispenser 244 is loaded with up to 10 spare liners in a rolled up configuration therein. The liner dispenser 244 may be located on and attached to the receiving member 114 itself, as shown in FIG. 23. Alternatively, the liner dispenser 244 may be attached to any portion of the excrement retrieving device 110. In the preferred embodiment of the present invention, the liner dispenser 244 is located on the receiving member 114. In this regard, a single liner 118 can be dispensed and immediately placed on the receiving member opening 126 as the liner 118 is being pulled out of the liner dispenser 244. The free end 246 of the liner 118 may be attached to the receiving member 114 via studs 220, adhesive, hooks and loops, or any suitable attachment method. The other end 248 of the liner 118 does not have to be directly be attached to the receiving member 114 as previously discussed; rather, the liner end 248 may be indirectly attached to the receiving member 114. In particular, this end 248 of the liner 118 is attached to the liner dispenser 244.

The rod member 130 is attached at its first end 132 to the receiving member 114. More specifically, the rod member 130 attaches to the first end 164 of the two prongs 160, 162. The rod member 130 is attached at its second end 134 to the handle grip member 138.

The handle grip member 138 serves to provide the user a member to grasp to manipulate the device 110. The user manipulates the device 110 in general through the handle grip member 138. In this regard, the user will grasp the handle grip member 138 and place the receiving member 114 over the excrement. Additionally, the user will squeeze the handle grip member 138 so as to translate the receiving member 114 between the open position 142 and the closed position 144. Normally, squeezing the handle grip member will translate the receiving member from the open position 142 to the closed position 144. As such, during the squeezing movement, the handle grip member 138 will remove the excrement from the surface (i.e., the receiving member will scoop up the excrement from the surface). Since the user must squeeze the handle grip member 138 to scoop up the excrement from the surface, this gives the user added stability in manipulating the device 110.

What is claimed is:

1. An excrement retrieving device for facilitating the removal of an excrement from a surface, the device comprising:
a) a resilient invaginated receiving member deformable between an open position and a closed position, the closed position defining an inner receiving surface sized and configured to receive the excrement;
b) a liner extending external to the resilient invaginated receiving member defining a mating surface disposed on the inner receiving surface, and an excrement engaging surface;
c) a rod member having a first end and a second end, the first end being attached to the resilient invaginated receiving member; and
d) a handle grip member attached to the rod member second end, the handle grip member being able to mechanically actuate the resilient invaginated receiving member between the open position and the closed position in response to movement of the handle grip member.

2. The device of claim 1 wherein the resilient invaginated receiving member further defines two mating excrement engaging distal edges to facilitate removal of the excrement from a surface.

3. The device of claim 2 wherein the two mating excrement engaging distal edges overlap when the resilient invaginated receiving member is in the closed position.

4. The device of claim 2 wherein the two mating excrement engaging distal edges are serrated.

5. The device of claim 1 wherein the resilient invaginated receiving member is normally in the open position.

6. The device of claim 1 wherein the liner is contoured to the shape of the inner receiving surface.

7. The device of claim 1 wherein the liner is adhesively secured to the inner receiving surface.

8. The device of claim 1 wherein the liner excrement engaging surface is adhesive to retain the excrement on the excrement engaging surface.

9. The device of claim 8 wherein the liner excrement engaging surface is covered by a protective covering.

10. The device of claim 9 wherein a plurality of liners are disposed on top of one another thereby reducing the time to operate the device.

11. The device of claim 10 wherein the top liner is peelably removable from a lower liner for disposal of the top liner.

12. The device of claim 1 wherein the liner further comprises at least one tab to facilitate removal of the liner with excrement retained therein.

13. The device of claim 12 wherein the tab protrudes from the liner so as to be able to tie the liner closed.

14. The device of claim 1 wherein the handle grip member further comprises:
a) a holding member for manipulating the position of the resilient invaginated receiving member; and
b) a trigger for actuating the resilient invaginated receiving member between the open position and the closed position.

15. The device of claim 1 further comprising:
a) a shaft slideably disposed within the rod member, the shaft being attached to the trigger and sliding within the rod member in response to trigger movement, the shaft having a first end and a second end, the first end being pivotabbly engaged to the handle member, the second end being in contact with a link to facilitate detachment of the receiving member from the device, the link being pivotally engaged to the receiving member;
b) the resilient invaginated receiving member being attached to the shaft; and
c) a spring over the shaft within the rod member for translating the resilient invaginated receiving member to the open position.

16. A method of removing excrement from a surface, the method comprising the steps of:
a) grasping a device having a resilient invaginated receiving member, a liner having an adhesive excrement engaging surface, a rod member, and a handle grip member;
b) positioning the resilient invaginated receiving member in an open position over the excrement;
c) translating the resilient invaginated receiving member from the open position to a closed position encapsulating the excrement within the liner; and
d) removing the liner with the excrement retained on the liner excrement engaging surface.

17. An excrement retrieving device for facilitating removal of an excrement from a surface, the device comprising:
a) a receiving member traverseable between an open position and a closed position having an excrement receiving end, the receiving member further defining two prongs and two mating excrement engaging distal edges, the two prongs rotateably engaged to a link;
b) a liner disposed external to the receiving member covering the excrement receiving end, the liner and the receiving member being cooperatively sized and configured to receive the excrement;
c) a rod member having a first and second end, the rod member first end being rotateably attachable to the two prongs;
d) a shaft being slideably engageable within the rod member contacting the link but not fixedly attached thereto; and
e) a handle grip member attached to the rod member second end, movement of the handle grip member being able to mechanically actuate the receiving member between the open and the closed position.

18. The device of claim 17 further comprising a discharge mechanism for facilitating removal of the liner from the receiving member, the discharge mechanism comprising:
a) a handle portion being slideably engaged to the rod member between a retracted position and an extended position; and
b) a protrusion portion attached to the handle portion.

19. The device of claim 18 further comprises a fork attachable to the protrusion portion for disengaging the liner from the receiving member.

20. The device of claim 19 wherein the fork defines four prongs that extend from a fork base to adjacent the excrement engaging distal edges.

21. The device of claim 18 wherein the discharge mechanism is normally in a retracted position.

22. The device of claim 17 wherein at least one tab is attached to the liner to facilitate removal of the liner from the receiving member.

23. The device of claim 17 wherein the liner defines an excrement receiving surface, the excrement receiving surface having adhesive about its outer perimeter.

24. The device of claim 23 wherein the liner excrement engaging surface is covered by a protective covering.

25. The device of claim 17 wherein the liner defines an excrement receiving surface, the excrement receiving surface having adhesive continuously disposed thereon for retaining substances therein and for forming a sealed pouch.

26. The device of claim 17 further comprising adhesive placed on an excrement receiving surface at its lateral edge and placed at an interface between excrement engaging distal edges and liner lateral edges.

27. The device of claim 26 wherein the adhesive strength of the adhesive on the excrement receiving surface is greater than the adhesive strength of the adhesive at the interface between the excrement engaging distal edges and liner lateral edges.

28. The device of claim 25 wherein the liner excrement engaging surface is covered by a protective covering.

29. The device of claim 17 further comprising a collapsible wire frame rotatably attached to the excrement engaging distal edges forming an aperture for providing support to the liner.

30. The device of claim 17 further comprising at least one stud on each excrement engaging distal edge.

31. The device of claim 30 wherein the liner has one corresponding opening for each stud for hooking the liner onto each stud thereby securing the liner to the receiving member.

32. The device of claim 31 further comprising an arch rotateable over the stud to disengage the liner from the stud.

33. The device of claim 17 wherein the receiving member is normally in the open position.

34. The device of claim 17 wherein receiving member further comprises a boss on the outside of the receiving member for securing the liner to the receiving member.

35. The device of claim 17 wherein the receiving member is defined by two prongs having a first end and a second end, the prongs being rotatably attached at the prong first ends, the prongs having a concave configuration are sized and configured to receive excrement.

36. A method of removing excrement from a surface, the method comprising the steps of:
a) grasping a device having a receiving member, a liner having a tab, rod member, a discharge mechanism, and a handle grip member;
b) positioning the receiving member in the open position over the excrement;
c)translating a mid portion of the liner into the receiving member retaining a portion of the liner external to the receiving member by moving the handle grip member thereby removing the excrement from the surface; and
d) removing the liner with the excrement retained therein.
